(19) United States
(12) Patent Application Publication
(10) Pub. No.: US 2005/0082164 A1
(43) Pub. Date: Apr. 21, 2005

(54) Water treatment apparatus ensuring uniform quality of treated water

(75) Inventors: Yoshihiro Inamoto, Otsu-shi (JP); Tatsuya Hirota, Kyoto-shi (JP); Muneaki Sugimoto, Kusatsu-shi (JP); Yozo Kawamura, Koka-gun (JP); Minoru Kishi, Osaka (JP)

Correspondence Address: FOLEY AND LARDNER;SUITE 500, 3000 K STREET NW, WASHINGTON, DC, 20007, US

(73) Assignee: Sanyo Electric Co., Ltd.

(21) Appl. No.: 10/921,874

(22) Filed: Aug. 20, 2004

(30) Foreign Application Priority Data
Sep. 4, 2003 (JP) 2003-312798

(51) Int. Cl. C02F 1/461

(52) U.S. Cl. 204/228.1

(57) ABSTRACT

Water to be treated within a water tank is circulated between the water tank and an electrolysis vessel by means of a circulating pump. In the electrolysis vessel, hypochlorous acid is generated by electrolysis with a pair of electrodes. The generated hypochlorous acid is introduced into the water tank and used for sterilization of the water to be treated. A first three-way valve is controlled to guide the water to be treated within the electrolysis vessel either to the water tank or to a drain. For a prescribed period of time after the polarities of the electrodes constituting the electrode pair are switched to each other, the water to be treated within the electrolysis vessel is guided to the drain to prevent impurities attached to the electrode surface from being introduced into the water tank.

### BACKGROUND OF THE INVENTION

1. Field of the Invention

The present invention relates to water treatment apparatuses, and more particularly to a water treatment apparatus having an electrode pair immersed in water to be treated, and causing a compound generated by electrolysis with the electrode pair to act on the water to be treated.

2. Description of the Background Art

Conventionally, electrolysis using an electrode pair has been utilized for sterilization of water to be treated in a relatively small water tank, such as a pool, a public bathhouse, or a family bathroom. With the electrolysis, chlorine contained in the water to be treated is changed to hypochlorous acid, which is utilized for sterilization.

The sterilization process by electrolysis using the electrode pair is advantageous in that a required manpower can be reduced compared to the sterilization process using a chemical agent such as calcium oxide requiring careful handling.

As a specific example of the sterilization process, Japanese Patent Laying-Open No. 2001-170642, for example, discloses a technique to switch the number of electrode pairs to be energized based on the residual chlorine concentration in the water to be treated.

In the conventional water treatment apparatus utilizing electrolysis, however, filters have been provided as appropriate to remove impurities generated during the electrolysis process. The flow path of the water to be treated provided with such filters may lead to considerably lowered flow rate of the water to be treated, dependent on the amount of impurities. As the flow of the water to be treated is weakened, the flow for supplying the hypochlorous acid generated by the electrolysis to the water to be treated would also be weakened. As such, the conventional water treatment apparatus cannot keep the water to be treated as a target of sterilization in uniform quality.

Moreover, with the conventional water treatment apparatus, although hypochlorous acid generated by the electrolysis may be supplied to the water to be treated, constant and even supply of the hypochlorous acid to the water to be treated cannot be ensured. This again makes it difficult to keep uniform the quality of the water to be treated and sterilized with the conventional water treatment apparatus.

### SUMMARY OF THE INVENTION

The present invention has been made in view of the foregoing, and its object is to provide a water treatment apparatus which supplies a compound generated by electrolysis to water to be treated to ensure uniform quality of the treated water.

The water treatment apparatus according to an aspect of the present invention is a water treatment apparatus for treating water in a water tank, which includes: a pair of electrodes for performing electrolysis on water to be treated; an electrolysis vessel containing the water to be treated and the electrode pair therein; a pump for sending the water to be treated within the electrolysis vessel to the water tank; a discharge portion that can take a state enabling discharge of a content within the electrolysis vessel to a location other than the water tank and a state disabling the discharge; a power supply portion supplying electric power to the electrode pair; and a control portion controlling operations of the discharge portion and the power supply portion. The control portion controls the power supply portion to switch polarities between the electrodes of the electrode pair, and controls the discharge portion to remain in the state enabling the discharge of the content within the electrolysis vessel to the location other than the water tank from the time when the polarities are switched until a prescribed condition is fulfilled after the switching of the polarities.

According to the aspect of the present invention, the discharge portion is set to the state permitting the content within the electrolysis vessel to be discharged to a location other than the water tank when the polarities of the electrodes of the electrode pair are switched to each other in the electrolysis vessel, i.e., when the impurities attached to the electrode by then are considered to be stripped off therefrom.

According to the present invention, while a compound generated by the electrolysis process in the electrolysis vessel is supplied to the water tank, when there is a possibility that impurities stripped off from the electrode may be introduced into the water tank, the impurities are guided to a location other than the water tank. This prevents the situation where the impurities block the flow from the electrolysis vessel to the water tank, and as a result, the compound generated by the electrolysis process can be supplied to the water tank stably. Accordingly, it is possible to keep the quality of the water to be treated in the water tank uniform.

The water treatment apparatus according to another aspect of the present invention is a water treatment apparatus for treating water in a water tank, which includes: a pair of electrodes for performing electrolysis on water to be treated; an electrolysis vessel containing the water to be treated and the electrode pair therein; a pump for sending the water to be treated from the electrolysis vessel to the water tank; and a spreading portion spreading the water to be treated introduced into the water tank by the pump.

According to the other aspect of the present invention, the spreading portion ensures that the compounds generated by the electrolysis process in the electrolysis vessel are introduced into the water tank evenly.

According to the present invention, since the compounds generated by the electrolysis process in the electrolysis vessel can evenly be introduced into the water tank, the quality of the water to be treated in the water tank can be made uniform as a whole in the water tank.

The water treatment apparatus according to a further aspect of the present invention is a water treatment apparatus for treating water in a water tank, which includes: a pair of electrodes for performing electrolysis on water to be treated; an electrolysis vessel containing the water to be treated and the electrode pair therein; a pump for circulating the water to be treated between the electrolysis vessel and the water tank; and a control portion controlling power supply to the electrodes of the electrode pair and an operation of the pump. The control portion controls the operation of the pump independently from the power supply to the electrodes.

According to the further aspect of the present invention, the circulating means can continue the operation to circulate the water to be treated, even if the electrolysis process is not performed in the electrolysis vessel as the power supply to the electrodes is stopped.

Further, according to the present invention, the pump can circulate the water to be treated, even if the electrolysis process in the electrolysis vessel is not performed. As such, the quality of the water to be treated within the water tank can be made uniform.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration of an embodiment of a water treatment apparatus according to the present invention.

FIG. 2 is a control block diagram of the water treatment apparatus of FIG. 1.

FIG. 3 is a flowchart illustrating a process carried out by a control unit of the water treatment apparatus of FIG. 1 to supply an appropriate amount of hypochlorous acid to water within a water tank.

FIG. 4 schematically shows a configuration of a modification of the water treatment apparatus shown in FIG. 1.

FIG. 5 illustrates a structure of a sprinkler pipe in the water treatment apparatus shown in FIG. 4.

### DESCRIPTION OF THE PREFERRED EMBODIMENTS

Hereinafter, embodiments of the present invention will be described with reference to the drawings.

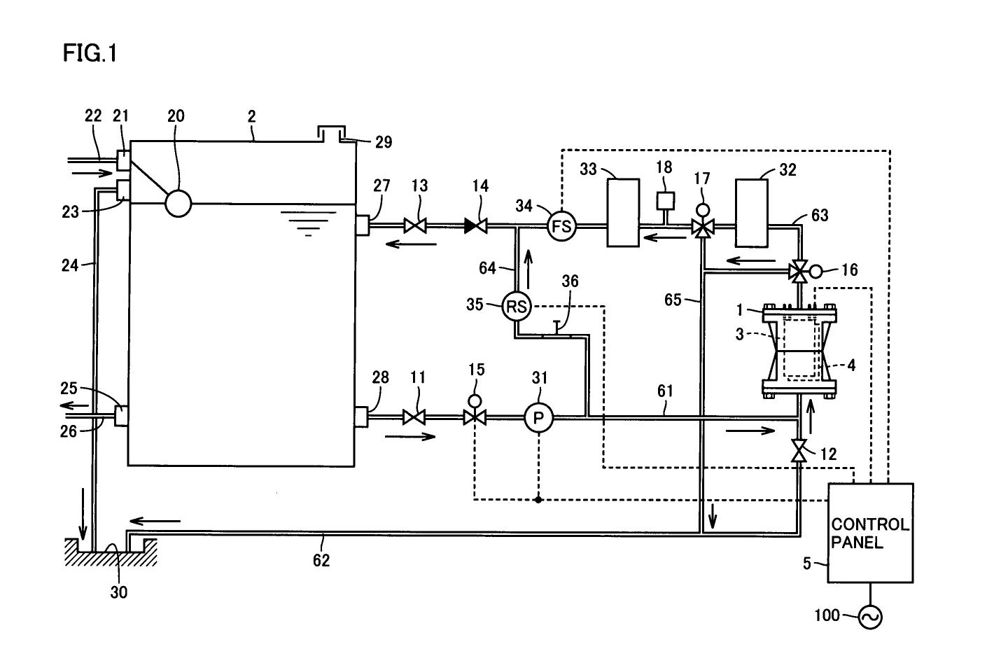

Referring to FIG. 1, the water treatment apparatus according to an embodiment of the present invention is arranged, e.g., on a rooftop of a building, condominium or the like, for supplying hypochlorous acid to the interior of a water tank 2 for domestic water supply. The water treatment apparatus includes, among others, an electrolysis vessel 1, a control panel 5 provided with electric power from an external commercial power source 100 and controlling operations of components of the water treatment apparatus, and pipes (pipe 61 and others) connecting electrolysis vessel 1 to water tank 2. The hypochlorous acid introduced into water tank 2 is used, e.g., for sterilization of tap water. The water treatment apparatus pools the tap water supplied from a water pipe in water tank 2, and also circulates the tap water between water tank 2 and electrolysis vessel 1 to mix the tap water with a liquid solution containing a compound obtained by electrolysis in electrolysis vessel 1. Herein, the water circulated between water tank 2 and electrolysis vessel 1 is called the water to be treated.

Water tank 2 has inlets 21, 27, outlets 23, 25, 28, a vent pipe 29, and a float 20. Water tank 2 is provided with tap water (water to be treated) from a pipe 22 via inlet 21. Inlet 21 is configured not to be in the open state when it is detected that the interior of water tank 2 is full by means of float 20. If the tap water or the water to be treated is further introduced into water tank 2 of the full state, the water to be treated within water tank 2 is flown out via outlet 23 to an overflow pipe 24 leading to a drain 30.

Water tank 2 is sealed. When the air pressure within water tank 2 exceeds a prescribed value, vent pipe 29 provided at the top of water tank 2 is opened. Water tank 2 supplies the water to be treated via outlet 25 to a water supply pipe 26. Water tank 2 supplies the tap water via water supply pipe 26 to each residence in the apartment building or the like.

The water to be treated within water tank 2 is guided via outlet 28 to a pipe 61 that is connected to electrolysis vessel 1. The water to be treated within electrolysis vessel 1 is guided to a pipe 63, which is connected to inlet 27. That is, the water to be treated within water tank 2 is circulated via pipe 61, electrolysis vessel 1, pipe 63, and back to water tank 2 in this order.

Pipe 61 is provided with a valve 11, a solenoid valve 15, and a circulating pump 31. Circulating pump 31 operates to guide the water to be treated from water tank 2 to electrolysis vessel 1, i.e., from solenoid valve 15 to electrolysis vessel 1. A pipe 64 is connected with pipe 61. Pipe 61 has its end connected to electrolysis vessel 1. Pipe 61 is also connected to a pipe 62. Pipe 62 is provided with a valve 12. When valve 12 is open, the water to be treated within pipe 62 is guided to drain 30.

Electrolysis vessel 1 accommodates the water to be treated and electrodes 3 and 4 immersed in the water to be treated therein. Electrodes 3, 4 are disposed to perform the electrolysis process on the water to be treated. One of electrodes 3, 4 serves as an anode electrode and the other as a cathode electrode. The supply of electric power to electrodes 3, 4 and polarities of electrodes 3, 4 are controlled via control panel 5.

As the electrolysis process is carried out, oxygen gas is generated by the electrolysis of water in the vicinity of the anode electrode within the water to be treated, as indicated by the following formulae (1) to (3). The chloride ions become chlorine gas, part of which is hydrated to become hypochlorous acid.
2H₂ [symbol] O₂↑+4H⁺+4e⁻ (1)
2Cl⁻ [symbol] Cl₂↑+2e⁻ (2)
Cl₂+H₂O [symbol] H⁺+Cl⁻+HClO (3)

In the vicinity of the cathode electrode within the water to be treated, hydrogen gas is generated by the electrolysis of water, as shown in the following formula (4).
2H₂O+2e⁻ [symbol] H₂↑+2O⁻ (4)

During the electrolysis process, the polarities of electrodes 3 and 4 are switched from each other. That is, electrode 3 may be the anode electrode and electrode 4 may be the cathode electrode at one point, while electrode 3 may be the cathode electrode and electrode 4 may be the anode electrode at another point.

With the electrolysis process, humic acid is attached to the anode electrode surface, which is used for generation of trihalomethane. As the polarities of electrodes 3 and 4 are switched from each other as described above, the humic acid attached to the surface of the electrode having served as the anode electrode comes off the electrode surface, as it now serves as the cathode electrode. The solid thus stripped off is let out of the water treatment apparatus as appropriate. This suppresses generation of trihalomethane in electrolysis vessel 1.

Pipe 63 is provided with a first three-way valve 16, a column 32, a second three-way valve 17, an evacuation valve 18, a filter 33, a flow switch 34, a check valve 14, and a valve 13. Column 32 is filled with corallite, healstone or the like. First and second three-way valves 16 and 17 are each connected to a pipe 65 as well. Each of first and second three-way valves 16 and 17 can take either the state adjusted to a “normal circulation side” for sending the water to be treated on pipe 63, or the state adjusted to a “discharge side” for sending the water to be treated from pipe 63 to pipe 65. Check valve 14 can send the water to be treated only from electrolysis vessel 1 to water tank 2, i.e., in the direction from flow switch 34 to valve 13. Pipe 64 has one end connected to pipe 63 between flow switch 34 and check valve 14. Pipe 64 has the other end connected to the outlet side of circulating pump 31 on pipe 61. Pipe 64 is provided with a constant flow valve 36 and a residual chlorine concentration sensor 35. As circulating pump 31 operates, the water to be treated within water tank 2 is guided to electrolysis vessel 1, although part of the water is sent via constant flow valve 36 to residual chlorine concentration sensor 35, instead of being sent to electrolysis vessel 1.

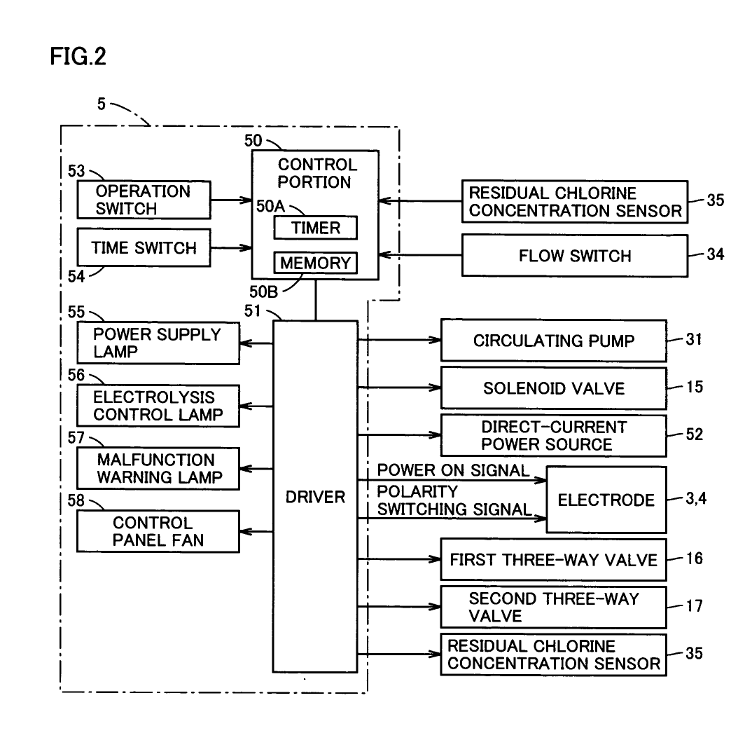

Referring to FIG. 2, control panel 5 of the water treatment apparatus includes a control portion 50 for processing various kinds of information within the water treatment apparatus, and a driver 51 controlled by control portion 50 to drive the various components of the water treatment apparatus. Control panel 5 further includes an operation switch 53 and a time switch 54, which are externally manipulated, a power supply lamp 55 for externally informing of the state of the water treatment apparatus, an electrolysis control lamp 56, a malfunction warning lamp 57, and a control panel fan 58 for cooling the interior of control panel 5.

Power supply lamp 55 is turned on while the power is supplied to the water treatment apparatus. Electrolysis control lamp 56 is turned on while the power is supplied to electrodes 3, 4 and the electrolysis process is in progress. Malfunction warning lamp 57 is turned on in the event of a malfunction of the water treatment apparatus.

Control portion 50 incorporates a timer 50A and a memory 50B therein, and receives information from residual chlorine concentration sensor 35 and flow switch 34.

The water treatment apparatus is provided with a direct-current power source 52 that converts the power input from an alternating-current power source 100 to direct-current power and supplies the same to the components of the water treatment apparatus.

Driver 51, based on the signals input from control portion 50, controls the operations of circulating pump 31, solenoid valve 15, direct-current power source 52, electrodes 3, 4, first three-way valve 16, second three-way valve 17, and residual chlorine concentration sensor 35. Particularly, driver 51 controls the operations of electrodes 3, 4 using information regarding power ON/OFF (i.e., a power ON signal) and information regarding polarities of the power to be supplied (i.e., a polarity switching signal).

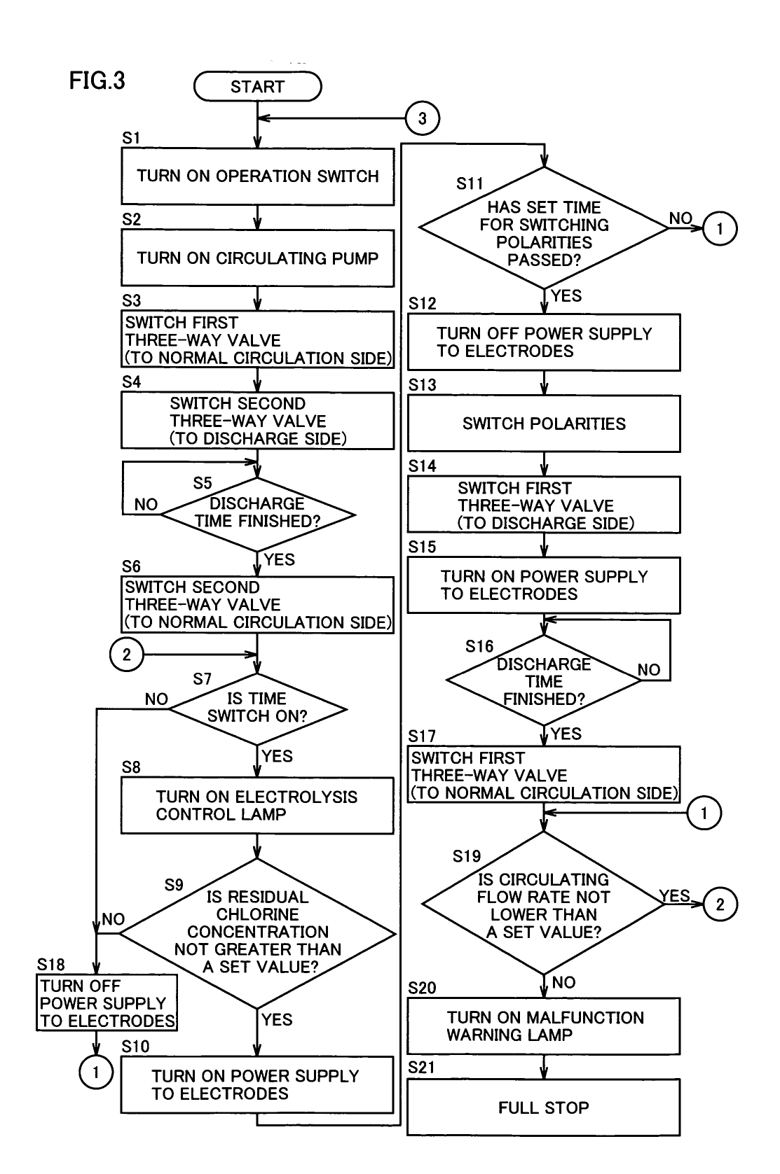

Hereinafter, the process performed by control portion 50 will be explained with reference to FIG. 3.

Firstly, in step S1 (hereinafter, “step” is not repeated), control portion 50 confirms that operation switch 53 is turned ON, and, in S2, it activates circulating pump 31.

Next, in S3, control portion 50 adjusts first three-way valve 16 to the normal circulation side. In S4, it adjusts second three-way valve 17 to the discharge side. As such, sediments and others having been deposited in electrolysis vessel 1 by then are let out of the water treatment apparatus before start of circulation of the water to be treated between water tank 2 and electrolysis vessel 1.

In S5, control portion 50 determines whether a “discharge time ” has passed after second three-way valve 17 was adjusted to the discharge side in S4. Herein, the “discharge time” refers to the period of time stored in advance in memory 50B, which corresponds to the period of time that is considered to be sufficient for the sediments and others deposited in electrolysis vessel 1 to be discharged through the process steps of S2-S4.

Next, in S6, control portion 50 adjusts second three-way valve 17 to the normal circulation side. This allows circulation of the water to be treated between water tank 2 and electrolysis vessel 1.

In S7, control portion 50 determines whether time switch 54 has been turned ON. If it is determined that the switch is ON, the process goes to S8. Otherwise, the process goes to S18.

In S18, control portion 50 turns OFF the power supply to electrodes 3, 4. The process then goes to S19.

On the other hand, in S8, control portion 50 turns on electrolysis control lamp 56, and, in S9, checks the detected value of residual chlorine concentration sensor 35 to determine whether the residual chlorine concentration within the water to be treated is at or lower than a set value that is preset and stored in memory 50B. If it is determined that the value is at the set value or lower, the process goes to S10. If it is determined that the value exceeds the set value, then, the power supply to electrodes 3, 4 is stopped in S18, and the process goes to S19.

In S10, control portion 50 turns ON the power supply to electrodes 3, 4. The power different in polarity from each other is supplied to electrodes 3 and 4 to make one of electrodes 3, 4 serve as the anode electrode and the other as the cathode electrode. With the power supplied to electrodes 3, 4, the electrolysis process according to the reaction formulae described above is carried out in electrolysis vessel 1. As the water to be treated is circulated between water tank 2 and electrolysis vessel 1, the hypochlorous acid generated by electrolysis in electrolysis vessel 1 is introduced into water tank 2.

Next, in S11, control portion 50 determines whether a set time for switching polarities has passed since the last time the polarities were switched between electrodes 3 and 4. The set time for switching polarities refers to a period of time predetermined as an interval for switching polarities between electrodes 3 and 4, which is stored in memory 50B. When it is determined that the set time for switching polarities has passed, the process goes to S12. Otherwise, the process returns to S1.

In S12, control portion 50 shuts OFF the power supply to electrodes 3, 4. In S13, control portion 50 switches the polarities of the power supplied to electrodes 3 and 4.

In S14, control portion 50 adjusts first three-way valve 16 to the discharge side. As such, the impurities within electrolysis vessel 1 are guided to drain 30, without being introduced into water tank 2 together with the water to be treated. In the present embodiment, the control is conducted such that the impurities are guided to drain 30 when the polarities of electrodes 3 and 4 are switched during the electrolysis process, i.e., when the impurities adhered to electrode 3 or 4 are stripped off the electrode surface due to the temporary stop of the power supply to electrodes 3, 4.

Next, in S15, control portion 50 turns ON the power supply to electrodes 3, 4. This presumably ensures that the impurities adhered to electrode 3 or 4 are surely stripped off the electrode surface, even if they are not removed by stoppage of the power supply, as the power of the polarity opposite from before is supplied to the relevant electrode surface.

In S16, control portion 50 determines whether a discharge time has passed since the adjustment of first three-way valve 16 to the discharge side in S14. The discharge time here is identical to the discharge time explained in conjunction with S5. When it is determined that the discharge time has passed, in S17, first three-way valve 16 is adjusted to the normal circulation side, and the process goes to S19.

In the above description, the valve is adjusted to the normal circulation side in S6 or S17, awaiting the lapse of the discharge time in S5 or S16. Alternatively, instead of determining whether a predetermined discharge time has passed in S5 and/or S16, the degree of transparency in electrolysis vessel 1 or the like may be detected, and the valve may be adjusted to the normal circulation side in S6 and/or S17 based on the detected result.

Next, in S19, control portion 50 checks a detected result of flow switch 34 to determine whether the flow rate of the water to be treated flowing through pipe 63 is not lower than a predetermined set value. If it is determined that the flow rate is at the set value or greater, the process returns to S7. If it is determined that the flow rate is lower than the set value, the process goes to S20.

In S20, control portion 50 turns on malfunction warning lamp 57. In S21, it stops the operations of all the components of the water treatment apparatus to terminate the process. That is, in the present embodiment, in the event that the flow rate of the circulating water decreases abnormally, the operations of all the components are automatically stopped and the malfunction is reported.

In the above-described embodiment, electrodes 3, 4 for the electrolysis process, and circulating pump 31 for circulating the water to be treated between water tank 2 and electrolysis vessel 1, have their operations controlled independently from each other. In other words, circulating pump 31 can continue its operation even if the power supply to electrodes 3, 4 is turned OFF. As such, except for the case where the circulating flow rate in pipe 63 decreases abnormally, the water to be treated constantly circulates in the water treatment apparatus by means of circulating pump 31, even if electrodes 3, 4 are not performing the electrolysis process. Accordingly, the residual chlorine concentration of the water to be treated circulated between water tank 2 and electrolysis vessel 1 can be kept uniform as a whole, and formation of biofilm in column 32 can also be suppressed.

Further, in the above-described embodiment, as in the process steps S9, S10 and Sl8, the power supply to the electrodes are turned ON/OFF based on the residual chlorine concentration of the water to be treated. More specifically, if the residual chlorine concentration of the water to be treated is greater than a predetermined set value, the electrolysis process is not conducted, since there is no need to supply the hypochlorous acid to the water to be treated. It is noted that, instead of providing the water treatment apparatus with residual chlorine concentration sensor 35 to control ON/OFF of the power supply to electrodes 3, 4 based on the residual chlorine concentration, a predetermined pattern may be stored in memory 50B to control ON/OFF of the power supply to electrodes 3, 4 based on the relevant pattern. Since the amount of the hypochlorous acid to be supplied to the water to be treated changes dependent on the outdoor air temperature, the temperature of the water to be treated itself and others, patterns corresponding to seasons may be stored in a plurality of memories 50B, in which case, control portion 50 can read the pattern corresponding to the current season from memory 50B to control ON/OFF of the power supply to electrodes 3, 4 in accordance with the read pattern.

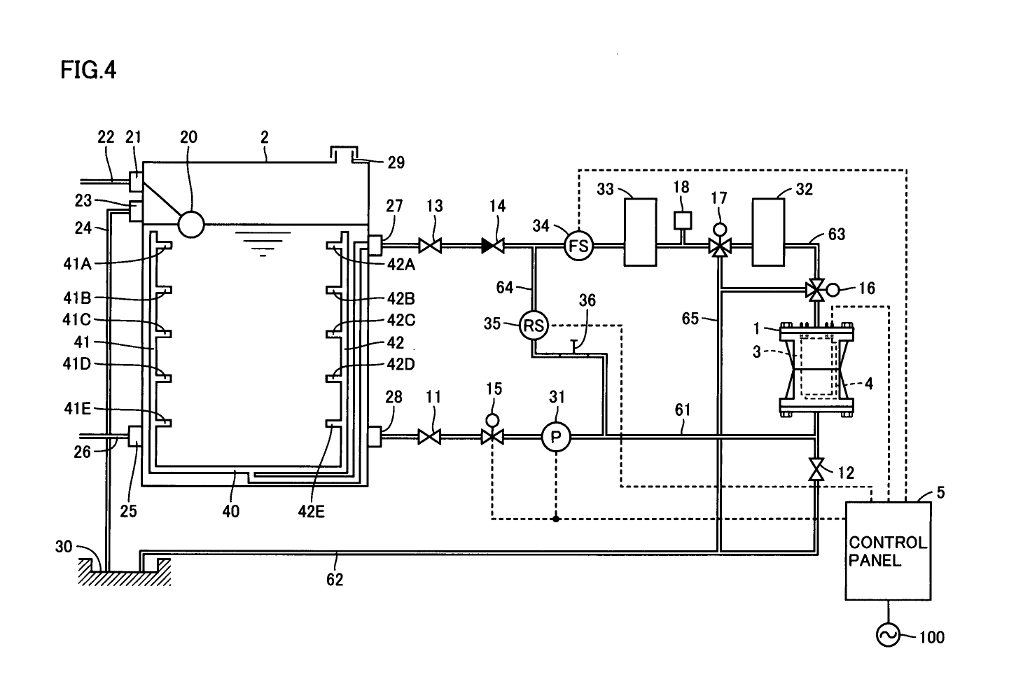

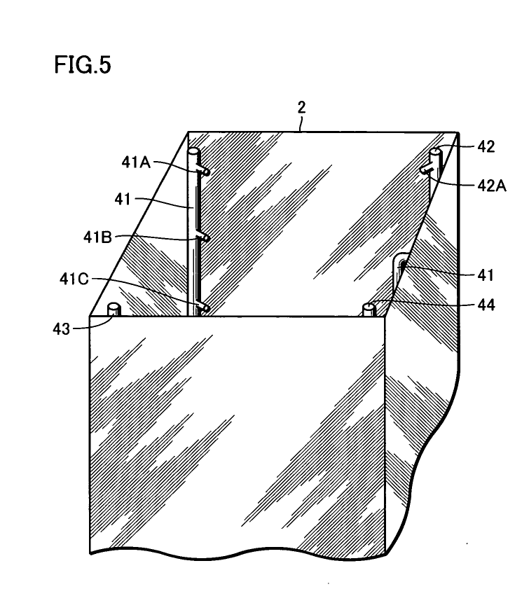

Now, a configuration of a modification of the water treatment apparatus of FIG. 1 is described with reference to FIG. 4. The water treatment apparatus shown in FIG. 4 differs from that of FIG. 1 in that it additionally includes a sprinkler pipe 40 disposed in water tank 2. FIG. 5 shows the interior of the water tank 2 of FIG. 4 when seen from diagonally above. In FIG. 5, some of the elements of water tank 2, such as an inlet 27, are not shown.

Referring to FIG. 5, sprinkler pipe 40 is branched into a plurality of pipes 41-44 within water tank 2. Pipes 41-44 are each provided with a plurality of discharge pipes 41A-41E, 42-42E, and others.

Sprinkler pipe 40 is connected to inlet 27. The water to be treated within pipe 63 is introduced via inlet 27 to sprinkler pipe 40. The water to be treated introduced to sprinkler pipe 40 is guided to pipes 41-44, and introduced into water tank 2 via discharge pipes 41A-41E, 42A-42E, and others.

In the water treatment apparatus of FIG. 4, the water to be treated is introduced into water tank 2 via the plurality of discharge pipes, so that the hypochlorous acid generated in electrolysis vessel 1 is supplied to the interior of water tank 2 evenly. That is, in the water treatment apparatus of FIG. 4, sprinkler pipe 40 having a plurality of discharge pipes serves as a spreading portion for spreading the water to be treated introduced into water tank 2.

As seen particularly from FIG. 5, pipes 41-44 are arranged, not at the center of water tank 2, but in the vicinity of the inner wall thereof. As such, the water to be treated supplied from the above-described discharge pipes to the interior of water tank 2 can effectively be scattered within water tank 2.

Further, the plurality of discharge pipes are attached to the corresponding pipes 41-44 to be directed to the center in the horizontal direction of water tank 2. This ensures more effective dispersion of the water to be treated supplied from the discharge pipes into water tank 2.

The water treatment apparatus of FIG. 4 may be equipped with a component which stirs the solution in water tank 2 instead of sprinkler pipe 40. In this case, the component serves as the spreading portion.

Although the present invention has been described and illustrated in detail, it is clearly understood that the same is by way of illustration and example only and is not to be taken by way of limitation, the spirit and scope of the present invention being limited only by the terms of the appended claims.

1. A water treatment apparatus for treating water in a water tank, comprising:
a pair of electrodes for performing electrolysis on water to be treated;
an electrolysis vessel containing the water to be treated and said electrode pair therein;
a pump for sending the water to be treated within said electrolysis vessel to said water tank;
a discharge portion that can take a state enabling discharge of a content within said electrolysis vessel to a location other than said water tank and a state disabling said discharge;
a power supply portion supplying electric power to said electrode pair; and
a control portion controlling operations of said discharge portion and said power supply portion; wherein
said control portion controls said power supply portion to switch polarities between the electrodes of said electrode pair, and controls said discharge portion to remain in the state enabling the discharge of the content within said electrolysis vessel to the location other than said water tank from the time when the polarities are switched until a prescribed condition is fulfilled after the switching of the polarities.

2. The water treatment apparatus according to claim 1, wherein said control portion determines that said prescribed condition is fulfilled when a predetermined period of time has passed.

3. The water treatment apparatus according to claim 1, wherein said discharge portion is formed of a three-way valve that can take a first state making a water passage for the water to be treated between said electrolysis vessel and said water tank, and a second state different from said first state and making a water passage for the water to be treated between said electrolysis vessel and the location other than said water tank.

4. The water treatment apparatus according to claim 1, further comprising a column provided in a flow path of the water to be treated between said electrolysis vessel and said water tank, and filtering the water to be treated provided from said electrolysis vessel before being introduced into said water tank.

5. A water treatment apparatus for treating water in a water tank, comprising:
a pair of electrodes for performing electrolysis on water to be treated;
an electrolysis vessel containing the water to be treated and said electrode pair therein;
a pump for sending the water to be treated from said electrolysis vessel to said water tank; and
a spreading portion spreading the water to be treated introduced into said water tank by said pump.

6. The water treatment apparatus according to claim 5, wherein said spreading portion is arranged in said water tank and stirs the water to be treated within said water tank.

7. The water treatment apparatus according to claim 5, wherein said spreading portion is a pipe having a prescribed length inside said water tank.

8. The water treatment apparatus according to claim 7, wherein said spreading portion is located in the vicinity of a wall surface inside said water tank.

9. A water treatment apparatus for treating water in a water tank, comprising:
a pair of electrodes for performing electrolysis on water to be treated;
an electrolysis vessel containing the water to be treated and said electrode pair therein;
a pump for circulating the water to be treated between said electrolysis vessel and said water tank; and
a control portion controlling power supply to the electrodes of said electrode pair and an operation of said pump; wherein
said control portion controls the operation of said pump independently from the power supply to said electrodes.

10. The water treatment apparatus according to claim 9, further comprising a storage portion storing a plurality of power supply patters to said electrodes, wherein
said control portion selects one of said plurality of power supply patterns in accordance with a prescribed condition, to determine the power supply pattern to said electrodes.
